(19) United States
(12) Patent Application Publication
(10) Pub. No.: US 2024/0039077 A1
(43) Pub. Date: Feb. 1, 2024

(54) ENERGY STORAGE RADIATORS

(71) Applicant: The Aerospace Corporation, El Segundo, CA (US)

(72) Inventors: Eric Joseph NEMANICK, Santa Monica, CA (US); Henry HELVAJIAN, Pasadena, CA (US); Adon DELGADO, JR., West Hills, CA (US); Kristine L. FERRONE, Pasadena, TX (US)

(73) Assignee: The Aerospace Corporation, El Segundo, CA (US)

(21) Appl. No.: 17/815,707

(22) Filed: Jul. 28, 2022

(51) Int. Cl. H01M 10/6551; B64G 1/42; B64G 1/44; H01M 10/617; H01M 10/625; H01M 10/46

(52) U.S. Cl. CPC H01M 10/6551; B64G 1/425; B64G 1/443; H01M 10/617; H01M 10/625; H01M 10/465; H01M 2220/20

(57) ABSTRACT

Energy storage radiators are disclosed. The structure of the radiator may be used as a battery to store and release energy, as well as serving to regulate the temperature of that battery and the associated device or vehicle. The structure may be configured to provide mechanical support, an enclosure, an attachment point, or an extension for a vehicle or a device. By designing an energy storage radiator to function as a battery, a separate battery superstructure may not be required. Also, the heat to be radiated away can be used to keep the battery in its operating temperature range. This may provide mass reduction of the radiator structures or materials, as well as make those materials multifunctional and replace material elsewhere with respect to conventional systems.

### FIELD

The present invention generally pertains to structures for temperature regulation, and more particularly, to energy storage radiators.

### BACKGROUND

Vehicles and other battery-powered systems and devices require radiators to passively manage component temperatures. Radiators are typically designed to have characteristics (emissivity, thermal transport, reflectivity, etc.) suitable for the given application. While radiators typically do not have substantial mass, they do add a mass penalty to the vehicle or device. Also, such radiators can be substantial in size. For applications where large amounts of heat must be dissipated, this mass becomes much more substantial since the heat transport and dissipation requirements are higher. For example, the radioisotope thermoelectric generators (RTGs) and their radiators used for deep space and Martian space vehicles are large, heavy, and inefficient. The thermal-to-electrical conversion efficiency is often negatively impacted by the radiator size and efficiency due to their tradeoffs with the mass and size of the radiators. These radiators are designed to transport heat away from heat sources, which are typically RTGs for space, but also may include combustion engines or other heat sources. This heat transport can be into the environment, but can also be designed to transport that heat to other parts of the vehicle to keep them warm using components such as heat pipes.

A key component to keep warm in many applications is the energy storage system, which is often a battery. Currently, vehicles use heat pipes from the hot portions of the vehicle or a resistive heater system powered by the electricity from the vehicle energy source(s) to keep the battery warm during operation. The additional heating components for indirectly heated batteries adds additional mass, per the above, and/or uses some of the vehicle or device electricity to inefficiently power the heaters. However, the heading components also add failure points for the critical battery system. For instance, current thermal designs potentially allow the battery to freeze if the heater is off or fails, or burn if the heater is on too long or otherwise malfunctions, leading to both battery and mission failure. Accordingly, an improved and/or alternative approach to temperature regulation may be beneficial.

### SUMMARY

Certain embodiments of the present invention may be implemented and provide solutions to the problems and needs in the art that have not yet been fully solved by existing temperature regulation technologies. For example, some embodiments pertain to energy storage radiators.

In an embodiment, an apparatus includes a first structure including a first radiative surface and energy storage components configured to store electrical energy (e.g., a battery). The first radiative surface of the first structure is configured to radiate sufficient heat from the first structure to maintain a temperature of the energy storage components within an operating range of the energy storage components.

In another embodiment, an energy storage radiator includes a structure including a first radiative surface and energy storage components configured to store electrical energy. The structure is configured to provide mechanical support, an enclosure, or an extension for a vehicle or a device. The first radiative surface of the structure is configured to radiate sufficient heat from the structure to maintain a temperature of the energy storage components within an operating range of the energy storage components.

In yet another embodiment, an energy storage radiator includes a structure including a first radiative surface and a second radiative surface. The energy storage radiator also includes energy storage components configured to store electrical energy. The first radiative surface and the second radiative surface of the structure are configured to radiate sufficient heat from the structure to maintain a temperature of the energy storage components within an operating range of the energy storage components.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a side partial exploded view illustrating an energy storage radiator, according to an embodiment of the present invention.

FIG. 2A illustrates a planar view thermal simulation of an RTG core, according to an embodiment of the present invention.

FIG. 2B illustrates a cross section view thermal simulation of the RTG core with an energy storage radiator surface, according to an embodiment of the present invention.

FIG. 3A is a perspective view illustrating a frame of a spacecraft with a single energy storage radiator attached to a face thereof, according to an embodiment of the present invention.

FIG. 3B is a perspective view illustrating the frame of the spacecraft with multiple energy storage radiators attached to a face thereof, according to an embodiment of the present invention.

FIG. 3C a perspective view illustrating the frame of the spacecraft with a single box-shaped energy storage radiator attached to a face thereof, according to an embodiment of the present invention.

FIG. 4A is a front perspective view illustrating a satellite with energy storage radiators attached to solar panels, according to an embodiment of the present invention.

FIG. 4B is a rear perspective view illustrating the satellite with a single energy storage radiator attached to each solar panel, according to an embodiment of the present invention.

FIG. 4C is a rear perspective view illustrating the satellite with multiple energy storage radiators attached to each solar panels, according to an embodiment of the present invention.

FIG. 5 is a perspective view illustrating a spacecraft with an internal energy storage radiator, according to an embodiment of the present invention.

FIG. 6 illustrates a nested-ring cell with multiple energy storage radiators, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to energy storage radiators. In some embodiments, the structure of the radiator may be used as a battery to store and release electrical energy, as well as serving to regulate the temperature of that battery and the associated device or vehicle (e.g., a spacecraft). As used herein, the “structure” is the outer surface of the energy storage radiator, namely, the material that physically encloses and/or includes the energy storage components. In some embodiments, the structure may be a case for the energy storage components. The structure may be configured to provide mechanical support, an enclosure, an attachment point, or an extension for a vehicle or a device.

By designing an energy storage radiator to function as a battery, a separate battery superstructure may not be required. Also, the heat to be radiated away can be used to keep the battery in its operating temperature range. Some embodiments provide mass reduction of the radiator structures or materials, as well as make those materials multifunctional and replace material elsewhere with respect to conventional systems. By making the battery from an existing critical system (i.e., the radiator), the radiator materials and structure can be enlarged, providing for more efficient radiation and energy production without substantially increasing the system mass, or even providing a mass reduction.

Conventional radiators have or are “fins” that increase the radiative surface area. However, fins are sub-optimal since they often face other radiator surfaces. Also, using a flat radiator would require boom extensions or other structures to gain unobstructed radiative pathways, increasing mass and complexity, which is a penalty for compact applications.

Lithium-ion is the dominant battery chemistry, and the operating range for liquid or gel electrolyte types of these batteries is typically rather narrow (i.e., from approximately 10° C. to 30° C.). Depending on the external environment and usage, the battery must be warmed or cooled to keep it in the operating range of the battery. In some embodiments, a solid state battery is used. In solid state batteries, the transport of lithium is slower than in liquid batteries, but solid state batteries normally operate well at higher temperatures (e.g., 60° C. to 80° C.), and have wide operating temperature ranges, such as from 0° C. to 140° C.

The energy storage radiator of some embodiments uses its own outer surface as a radiator, uses the surface to mount the radiative surface for the radiator, or both. The radiative characteristics, size, and position of the surface are selected to keep the battery within its operating temperature range. For instance, the emissivity may be tailored to obtain the desired temperature range, the size can be selected to keep the optimal temperature for a given heat flux, etc. The radiator design should take into account the rate at which heat needs to be dissipated to keep the battery temperature optimal. This could be 20° C., 80° C., or any other suitable temperature or range based on the characteristics of the selected battery.

The energy storage radiator could also dissipate heat using conductive or convective heat transport in addition to, or in lieu of, radiative heat transport in some embodiments. In conductive or convective heat transport, structures such as heat pipes or other thermal transport materials could conduct heat from the radiator to other locations in the vehicle or device or environment. In some embodiments, this heat is transported to warm other components of the vehicle or device to obviate the need for resistive heaters.

Per the above, some embodiments are well-suited for space applications, where mass is a significant constraint. However, terrestrial applications are also envisioned, such as for unmanned aerial vehicles (UAVs), subterranean drills and robots, personal electronics, electric and internal combustion cars, etc. In the case of UAVs, energy storage radiators may help these systems to meet their strict thermal management requirements, as well as reduce weight, which can extend the flight time for the UAV between charges.

Some embodiments employ a solid state lithium battery with an operating temperature designed to be compatible with the thermal design of the application. The radiator equilibrium temperature is tuned in the design phase to keep the battery components in the optimal temperature range during the operation of the battery. Also, the radiator is designed to have an electrical charge and discharge temperature sufficient to meet the power system needs. These aspects can be tailored with the size, insulation, and geometry of the radiator system.

The energy storage radiator of some embodiments takes a critical spacecraft system, namely, the radiator, and adds an energy storage function. The energy storage radiator uses the radiative structure to displace traditional, separate battery structural mass. This may allow larger, more efficient radiators for a given mass and size allowance.

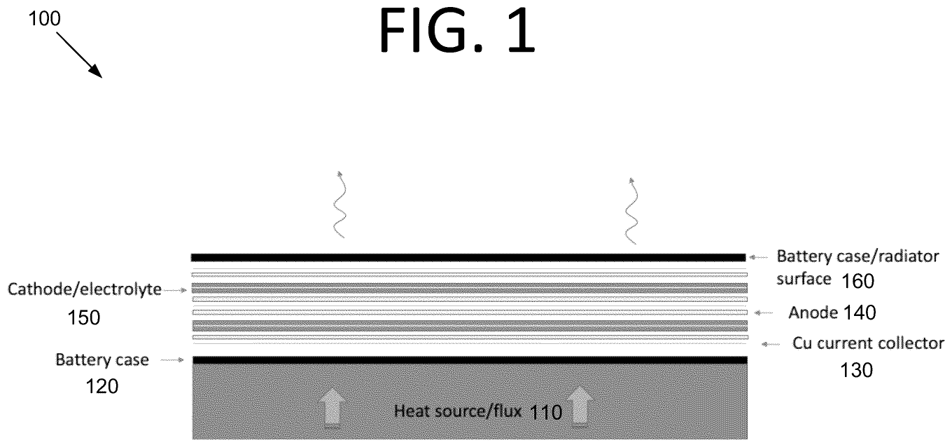

FIG. 1 is a side partial exploded view illustrating an energy storage radiator 100, according to an embodiment of the present invention. A heat source/flux 110 heats an internal battery case 120. This heat source can be from an internal source, such as decaying isotopes from a radioisotope thermoelectric generator, or an external source, such as solar exposure. A current collector 130, which is copper in this embodiment, but may be made from other suitable current collection materials, such as gold, titanium, carbons, any other suitable conductive material, any combination thereof, etc., collects and transfers electrical energy generated by the battery to the system bus (not shown), or transfers energy from the system bus to the electrodes for battery storage. Anode 140 and cathode/electrolyte 150 provide the negatively and positively charged portions of the battery, respectively. A radiative surface 160 functions as a case and radiates heat from the battery into the environment or other vehicle or device systems.

Solid state battery electrolytes, such as lithium phosphorus oxynitride (LiPON), lithium phosphosulfide (LiPSₓ), lithium superionic conductor (LiSICON), lithium conducting polymers, etc., may be used to ensure that the battery can operate at a higher, wider temperature range. For instance, a lithium-ion battery using LiPON may be designed to operate between 60° C. and 140° C. Importantly, this provides a wider range for operating the radiator temperatures over the life of the battery since the battery radiator temperature may change over life through degradation of the radiator's ability to emit energy. Also, the exterior material(s) can be tailored to meet emissivity requirements for the radiator, in addition to containing the battery materials and components. The exterior material(s) may include steels, aluminum alloys, carbons and carbon fiber, polymers, any other suitable material, any combination thereof, etc. The emissivity of the exterior material can be altered to increase or decrease the temperature of the radiator to keep the temperature within the desired temperature range. Emissivity materials may include carbons, metals, metal oxides, ceramics, photonic crystals, any other suitable material, any combination thereof, etc.

Currently, radiator materials and designs are fundamentally divided from, and separated from, energy storage capability. Radiators are designed to appropriately transport heat to other components or the environment. The radiator surface is designed to emit heat without absorbing excess thermal radiation. Batteries are a critical vehicle system, whose heating and thermal regulation are a strain on vehicle design. By combining these systems, excess heat being dissipated or distributed by the radiator can be used by the battery to keep warm, removing the need to heat the battery separately through the use of electric resistive heaters.

Battery designs, with their layers of metal foils, carbons, and ceramics in some embodiments, ensure good thermal transport in the battery for uniform heat distribution. Battery materials are already good thermal transport structures since battery performance is linked to uniform temperature, and inserting these materials into the radiator should not significantly impair the heat transfer performance of the radiator. For some applications in space, radiators are not intended to be too large or too efficient at dissipating heat since as they only balance a small amount of heat produced in the vehicle with the passive radiation of heat into space. However, in some high temperature applications, such as RTGs, internal combustion engines, or UAVs, the core temperatures can be very high, and large and efficient radiators are needed without imposing mass penalties.

Increasing radiator size by combining its mass with that of the battery can improve the energy conversion of thermoelectric devices. Thermoelectric energy conversion is dependent on the absolute difference between the hot and cold shoes, which are the two ends of the thermoelectric junctions in the RTG. A larger radiator can lower the T_{cold} for a higher efficiency. The figure of merit for a thermoelectric device, ZT, is given by:

$$ZT = \frac{{S}^{2} T}{ρ λ} \qquad ( 1 )$$

$${η}_{max} = \frac{{T}_{hot} - {T}_{cold}}{{T}_{hot}} \cdot \frac{\sqrt{1 + ZT} - 1}{\sqrt{1 + ZT} + \frac{{T}_{cold}}{{T}_{hot}}} \qquad ( 2 )$$

where T is the absolute temperature of the heat source that the energy is being converted from, Tₕₒₜ is the hot shoe temperature, T_{cold} is the cold shoe temperature, S is the Seebeck coefficient of the thermoelectric material, ρ is the electrical resistivity of the thermoelectric material, λ is thermal conductivity of the thermoelectric material, and ηₘₐₓ is the maximum efficiency for a thermoelectric device.

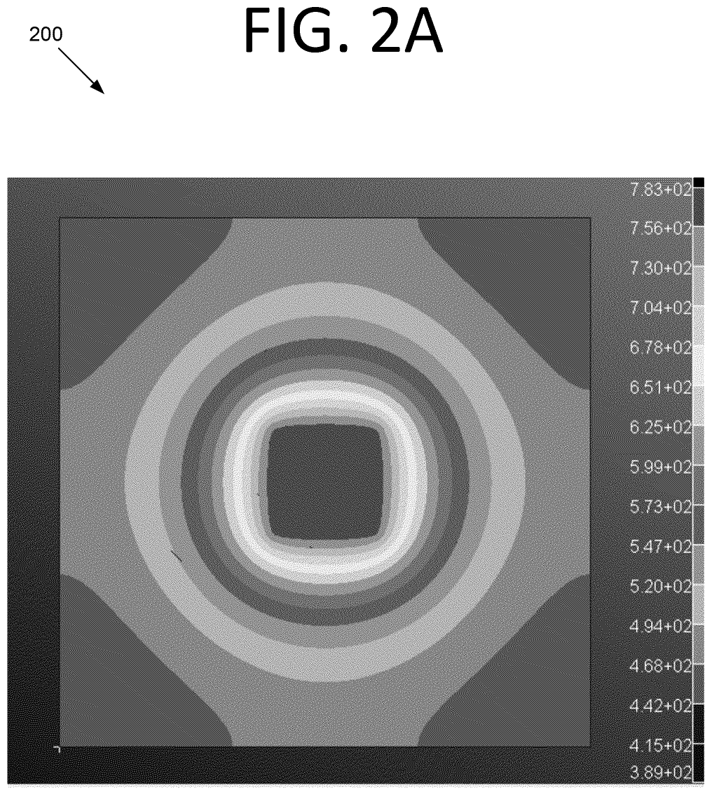

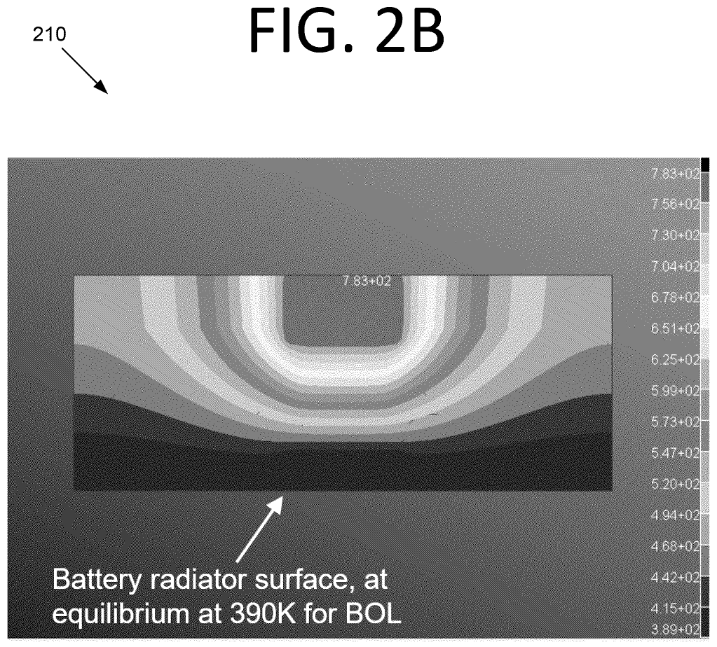

Simulations of an RTG design for deep space missions show that an energy storage radiator can function to regulate RTG and thermoelectric temperature while storing energy and maintaining a battery functional temperature over life. FIG. 2A illustrates a planar view thermal simulation 200 of an RTG core and FIG. 2B illustrates a cross section view thermal simulation 210 of the RTG core with an energy storage radiator surface, which is at equilibrium at 390 K for the beginning or life (BOL) of the RTG. The relatively compact RTG for deep space missions used a large, flat radiator with energy storage layers at the radiator surface and had a thermoelectric conversion efficiency 37% better than the NASA Multi-Mission RTG (MMRTG) using the same isotope and thermoelectrics. This was primarily due to the larger radiator aspect ratio (i.e., 25:1 versus 5:1). This larger radiator displaced the battery mass for the vehicle, resulting in an overall decrease in mass, as well as the efficiency increase.

The energy storage radiator of some embodiments addresses the high heat rejection issues of RTGs and close solar approach missions noted above. Energy storage radiators may also be beneficial for planetary rover designs, including small vehicles with limited mass and/or surface area. Energy storage radiators may further be beneficial for heat dissipation from solar cells for photovoltaic-powered spacecraft, potentially eliminating battery heater requirements. Additionally, the energy storage radiator of some embodiments may operate as a heat sink, taking heat from incident solar or environmental sources to heat the battery without the need for electrical power to do so.

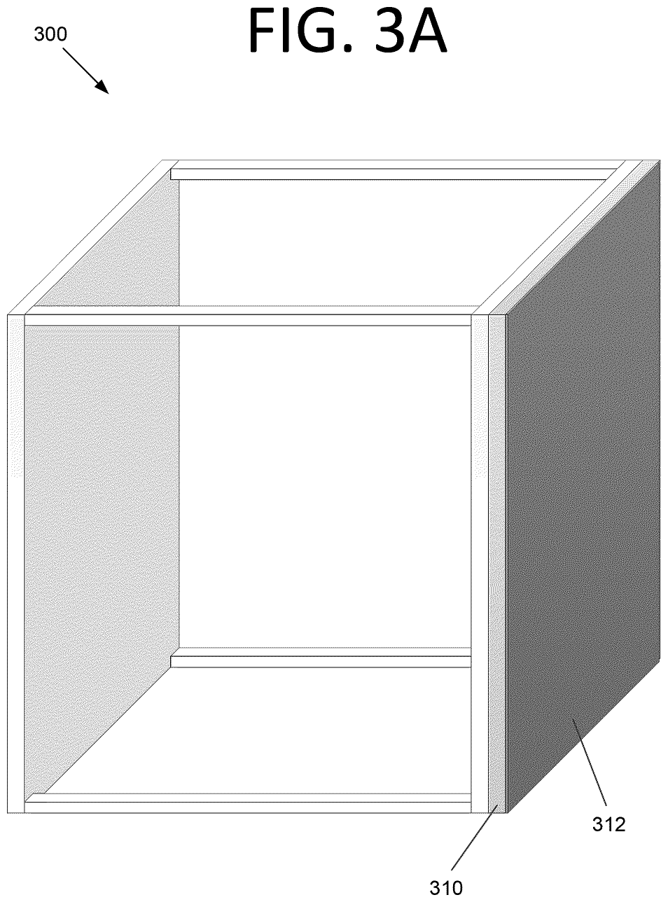

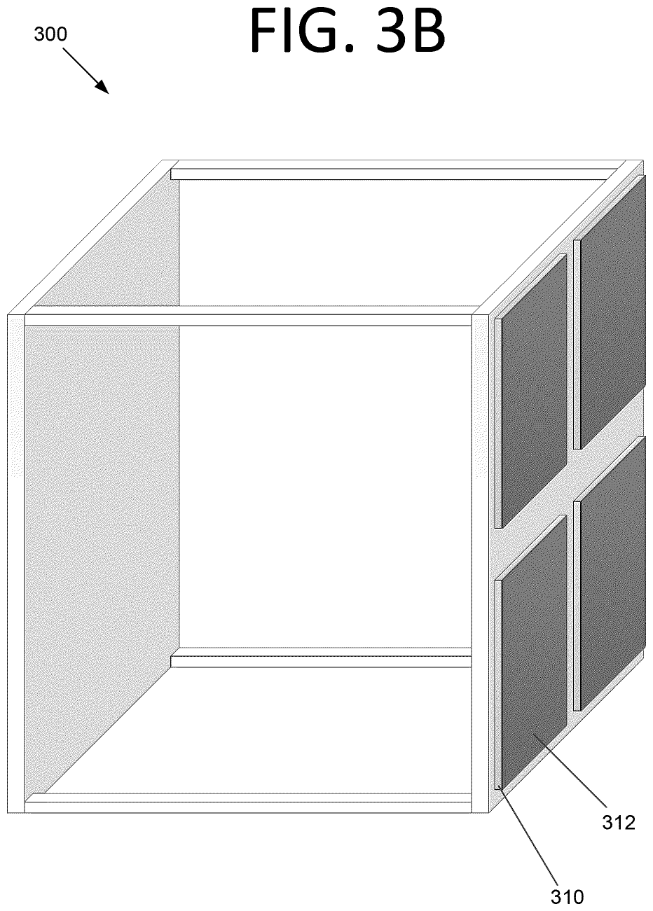

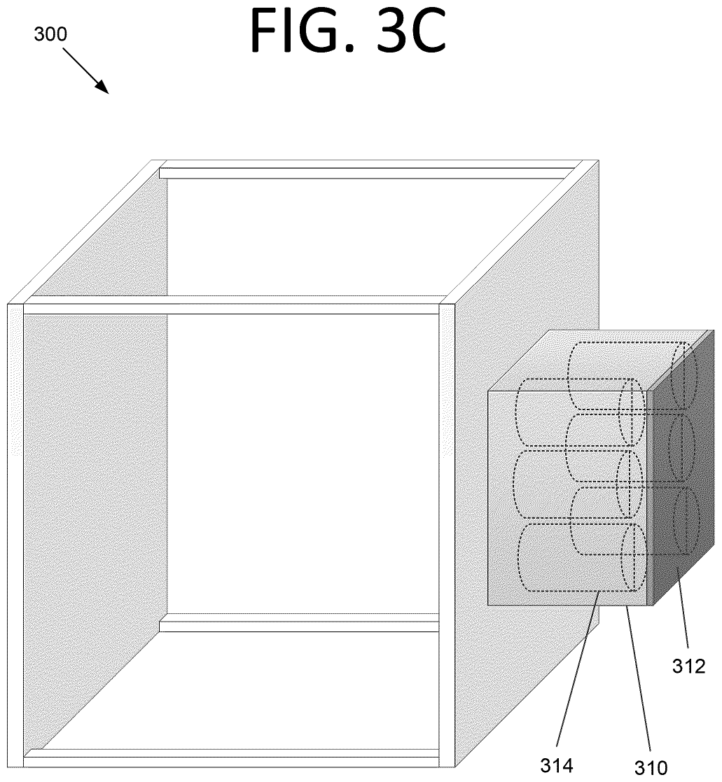

The energy storage radiators of some embodiments may have various shapes and sizes, and may be located at various location(s) on various spacecraft. For instance, FIG. 3A illustrates a frame 300 of a spacecraft with a single energy storage radiator 310 attached to a face thereof. It should be noted, however, that energy storage radiator 310 may be used for any other spacecraft design without deviating from the scope of the invention. An outer radiative surface 312 of energy storage radiator 310 radiates heat away from the spacecraft and into space. Energy storage radiator 310 contains layers of energy storage materials (e.g., battery components, such as those shown in FIG. 1 and described above) and connections to the vehicle electrical bus (not shown). Multiple energy storage radiators are also possible. See, for example, FIG. 3B.

The energy storage radiator does not need to be relatively flat in some embodiments. For instance, in FIG. 3C, battery 310 has a box shape and includes multiple cells 314. Outer radiative surface 312 still radiates heat away from the spacecraft after energy storage radiator 310 has transported heat from the inside of the spacecraft to outer radiative surface 312. However, in some embodiments, multiple external faces, such as the top face, side face(s), and/or bottom face of energy storage radiator 310 may include radiative surfaces.

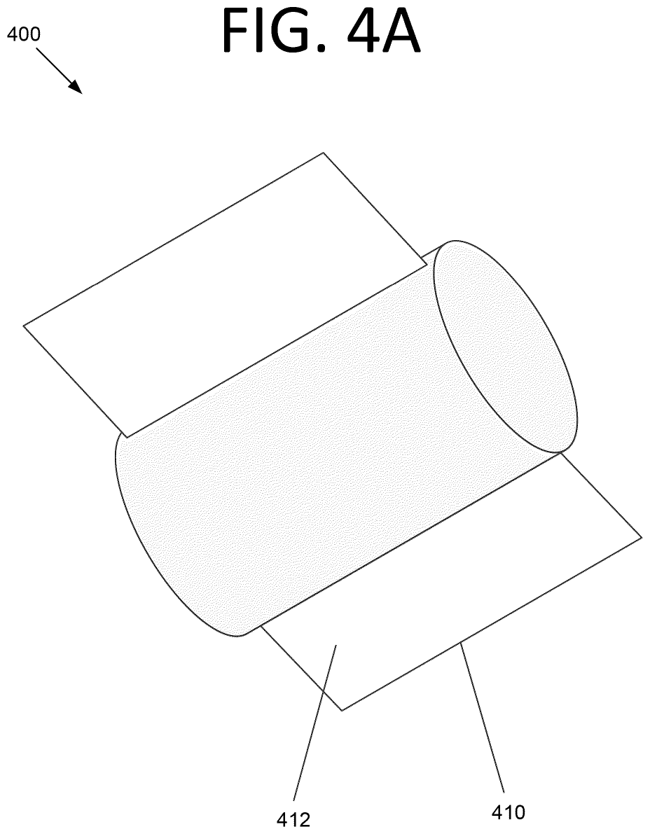

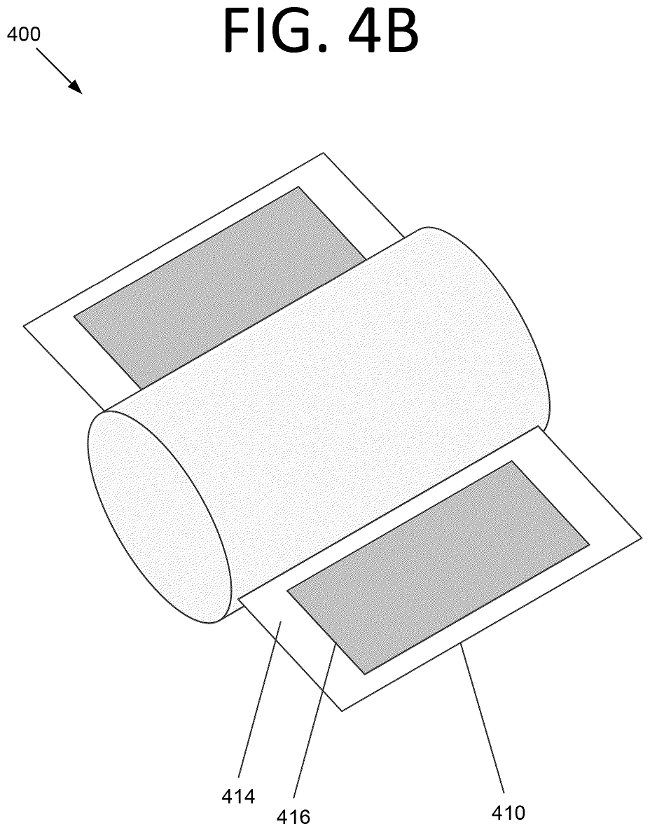

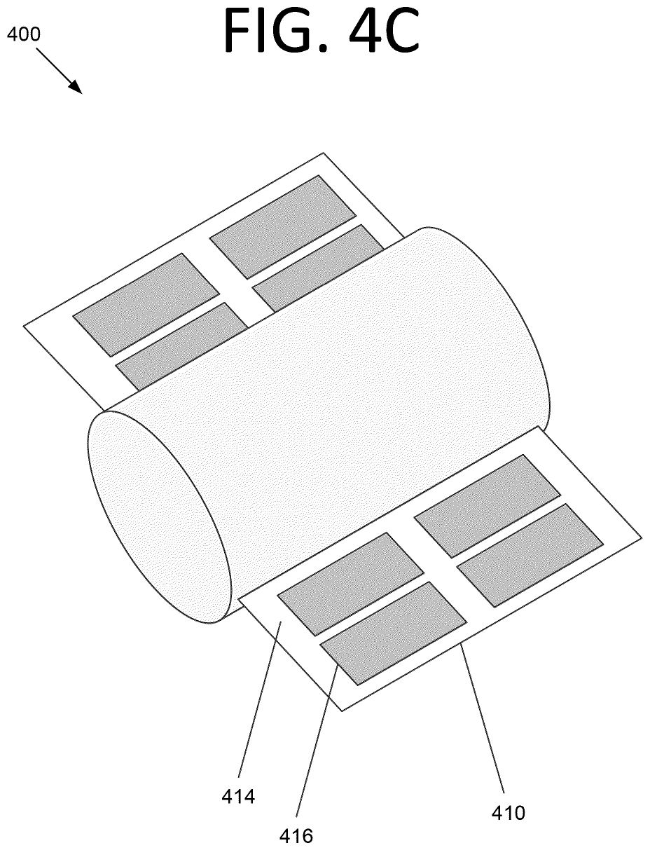

Per the above, in some embodiments, energy storage radiators may be attached on the non-power-generating surfaces of solar panels. Referring to FIG. 4A, a satellite 400 includes two solar panels 410 with a power-generating surface 412. Power-generating surface 412 includes photovoltaics that generate electricity when facing the sun. A rear surface 414 of solar panel 410 includes a single energy storage radiator 416 (FIG. 4B) or multiple energy storage radiators 416 (FIG. 4C). The embodiment of FIGS. 4A-C radiates the heat from solar panels 410 through energy storage radiators 416 to the radiative surface of energy storage radiators 416 that is pointed away from the sun, cooling the photovoltaics and maintaining the temperature of the energy storage components of energy storage radiators 416.

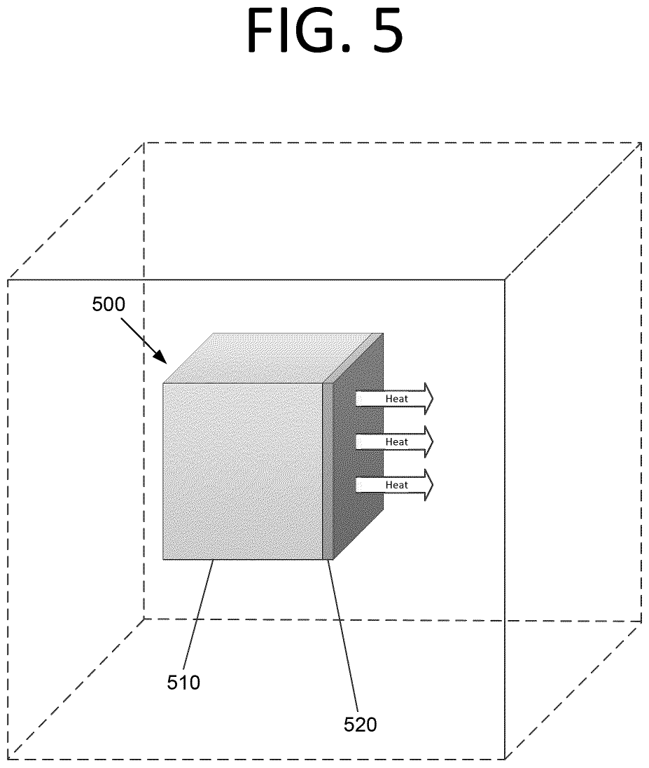

In some embodiments, the energy storage radiator may be internal, providing a heat source or a cold sink for a given component. FIG. 5 illustrates a spacecraft with an internal energy storage radiator 500. Energy storage radiator 500 includes a battery 510 and an outer radiative surface 520.

When acting as a heat source for a given component, energy storage radiator 500 transports heat from a hot location in the spacecraft to a cold location, warming the target component. When acting as a cold sink, energy storage radiator 500 transports heat from a hot component to a cold location, cooling the target hot component. In this embodiment, energy storage radiator 500 acts to simultaneously cool one component of the vehicle while heating another, all the while storing electrical energy. Outer radiative surface 520 may be used to radiate heat towards another component, to keep the interior of spacecraft 500 warm, or both.

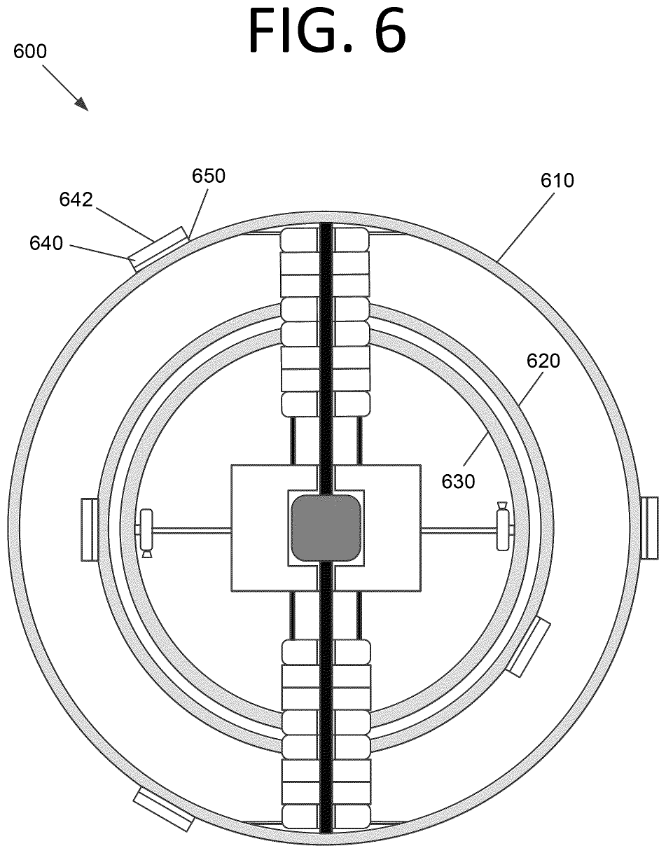

Some embodiments may be used for nested ring cell-based space vehicles, such as those described in U.S. Pat. No. 11,155,366. FIG. 6 illustrates a nested-ring cell 600, according to an embodiment of the present invention. In this embodiment, nested ring cell 600 includes three rings—an outer ring 610, a middle ring 620, and an inner ring 630. In this embodiment, rings 620, 630 are rails that include energy storage radiators 640 mounted to movable trams 650. Outer radiative surfaces 642 of energy storage radiators 640 radiate heat away from nested-ring cell 600. Such a nested-ring cell 600 may use energy storage radiators 640 to power itself, and potentially to power other cells in an ensemble of cells.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
a first structure comprising a first radiative surface and energy storage components configured to store electrical energy, wherein
the first radiative surface of the first structure is configured to radiate sufficient heat from the first structure to maintain a temperature of the energy storage components within an operating range of the energy storage components.

2. The apparatus of claim 1, wherein the first radiative surface comprises carbon, a metal, a metal oxide, a ceramic, photonic crystals, or any combination thereof.

3. The apparatus of claim 1, wherein the energy storage components are components of a solid state battery configured to operate at temperatures between 0° C. and 140° C.

4. The apparatus of claim 1, wherein the first structure comprises a second radiative surface configured to radiate sufficient heat from the first structure to maintain the temperature of the energy storage components within the operating range of the energy storage components together with the first radiative surface.

5. The apparatus of claim 1, further comprising:
a second structure comprising a radiative surface and energy storage components configured to store energy, wherein
the radiative surface of the second structure is configured to radiate sufficient heat from the second structure to maintain a temperature of the energy storage components of the second structure within an operating range of the energy storage components of the second structure.

6. The apparatus of claim 1, further comprising:
a spacecraft, wherein
the first structure is located within the spacecraft.

7. The apparatus of claim 1, further comprising:
a solar panel, wherein
the first structure is located on a surface of the solar panel opposite a power generation surface of the solar panel, and
the first structure is configured to obtain power from the solar panel.

8. The apparatus of claim 1, further comprising:
a nested-ring cell space vehicle comprising a tram, wherein
the first structure is operably connected to the tram of the nested-ring cell space vehicle.

9. The apparatus of claim 1, wherein the apparatus is or comprises an energy storage radiator.

10. The apparatus of claim 1, wherein the first structure is configured to provide mechanical support, an enclosure, an attachment point, or an extension for the apparatus.

11. The apparatus of claim 1, wherein the energy storage components comprise, a current collector, an anode, and a cathode/electrolyte.

12. An energy storage radiator, comprising:
a structure comprising a first radiative surface and energy storage components configured to store electrical energy, wherein
the structure is configured to provide mechanical support, an enclosure, an attachment point, or an extension for a vehicle or a device, and
the first radiative surface of the structure is configured to radiate sufficient heat from the structure to maintain a temperature of the energy storage components within an operating range of the energy storage components.

13. The energy storage radiator of claim 12, wherein the first radiative surface comprises carbon, a metal, a metal oxide, a ceramic, photonic crystals, or any combination thereof.

14. The energy storage radiator of claim 12, wherein the energy storage components are components of a solid state battery configured to operate at temperatures between 0° C. and 140° C.

15. The energy storage radiator of claim 12, wherein the structure comprises a second radiative surface configured to radiate sufficient heat from the structure to maintain the temperature of the energy storage components within the operating range of the energy storage components together with the first radiative surface.

16. The energy storage radiator of claim 12, wherein the structure is located within a spacecraft.

17. The energy storage radiator of claim 12, wherein
the structure is located on a surface of a solar panel opposite a power generation surface of the solar panel, and
the structure is configured to obtain power from the solar panel.

18. The energy storage radiator of clam 12, wherein the structure is operably connected to a tram of a nested-ring cell space vehicle.

19. An energy storage radiator, comprising:
a structure comprising a first radiative surface and a second radiative surface; and
energy storage components configured to store electrical energy, wherein
the first radiative surface and the second radiative surface of the structure are configured to radiate sufficient heat from the structure to maintain a temperature of the energy storage components within an operating range of the energy storage components.

20. The energy storage radiator of claim 19, wherein the structure is configured to provide mechanical support, an enclosure, an attachment point, or an extension for a vehicle or a device.
